(19) United States
(12) Patent Application Publication
(10) Pub. No.: US 2025/0069321 A1
(43) Pub. Date: Feb. 27, 2025

(54) RECONSTRUCTIVE LATENT-SPACE NEURAL RADIANCE FIELDS (RELS-NERF) FOR 3D SCENE REPRESENTATIONS

(71) Applicant: SAMSUNG ELECTRONICS CO., LTD., Suwon-si (KR)

(72) Inventors: Tristan AUMENTADO-ARMSTRONG, Toronto, CA (US); Ashkan MIRZAEI, Toronto (CA); Aleksai LEVINSHTEIN, Thornhill (CA); Marcus Anthony BRUBAKER, Toronto (CA); Konstantinos G. DERPANIS, Toronto (CA); Igor GILITSCHENSKI, Toronto (CA)

(73) Assignee: SAMSUNG ELECTRONICS CO., LTD., Suwon-si (KR)

(21) Appl. No.: 18/800,919

(22) Filed: Aug. 12, 2024

Related U.S. Application Data
(60) Provisional application No. 63/540,571, filed on Sep. 26, 2023.
(60) Provisional application No. 63/534,080, filed on Aug. 22, 2023.

(51) Int. Cl. G06T 15/20; G06T 15/06

(52) U.S. Cl. CPC G06T 15/205; G06T 15/06

(57) ABSTRACT

An electronic device includes: a camera; a memory; a processor to obtain a plurality of multiview color images of the object; obtain, from the latent field about the object, a plurality of multiview latent images and a plurality of camera parameters respectively corresponding to the plurality of multiview latent images; based on the plurality of multiview latent images and the plurality of camera parameters, render a first feature map about the object by using a latent field and an autoencoder; based on the first feature map about the object, train the improved NeRF by performing iterative operations; receive a request for a novel view of the object; generate, by using the improved NeRF, a second feature map from the novel view of the object; and generate, by a decoder of the autoencoder, an image about the novel view of the object based on the second feature map.

### CROSS-REFERENCE TO RELATED APPLICATIONS

This application is based on and claims priority under 35 U.S.C. § 119 to U.S. Provisional Patent Application Nos. 63/534,080, filed on Aug. 22, 2023, and 63/540,571, filed on Sep. 26, 2023, in the United States Patent and Trademark Office, the disclosures of which are incorporated by reference herein in their entireties.

### BACKGROUND

### 1. Field

The disclosure relates to a system and a method for an improved neural radiance field (NeRF) model (operations), which is called a ‘reconstructive latent-space NeRF’ model (in short, ReLS-NeRF), for particular applications (such as three dimensional (3D) scene representations) running on electronic devices.

### 2. Description of Related Art

Neural rendering techniques continue to grow in importance. In particular, NeRF (model or operations) is effective for high-quality novel view synthesis of complex scenes. NeRF produces 3D representations derived from two dimensional (2D) image sets. Simply put, NeRF is used to derive 3D representations of a scene or an object from multiview 2D image sets (i.e., a set of pictures taken of the scene or the object).

NeRF is used for novel view synthesis, which corresponds to a task of rendering the scene from a new (previously unseen) viewpoint. NeRF can provide the rendered novel views with high fidelity, based on sufficient data and appropriate optimization (training or fitting) of the NeRF.

NeRF has been utilized for multiple applications, such as content creation, robotics tasks (e.g., including 6 depth of field (DoF) tracking), pose estimation, surface recognition or reconstruction, motion planning, reinforcement learning, tactile sensing, and photorealistic simulation. However, slow rendering and qualitative artifacts of NeRF impede further use cases in production. While NeRF has been applied to graphics, vision, and robotics, problems with slow rendering speed and characteristic visual artifacts of the existing NeRF prevent adoption in many cases.

In the existing NeRF, to render a single pixel, one major bottleneck is a need for multiple forward passes of a multilayer perceptron (MLP). The MLP is a type of artificial neural network including multiple layers of neurons. In general, the neurons in the MLP, which combine linear transformations with nonlinear activation functions, allow the neural network to learn complex patterns in data. The MLP can learn nonlinear relationships in data, thus the MLP can be a useful tool for tasks such as classification, regression, and pattern recognition.

In the existing NeRF, replacing or augmenting the MLP with alternative representations (e.g., voxel grids or feature hash-tables) has been used to improve both training speed and inference speed. To reduce test-time rendering speed (or inference speed), for example, baking NeRF into other primitive representations has been a popular approach. Separately, alternative sampling methods, different radiance models, and scene contraction functions have been proposed to reduce artifacts (e.g., “floaters”).

Despite these approaches, NeRF still suffers from visual flaws and low rendering frame-rates. Thus, NeRF has not yet been adopted for many applications (for example, running on smartphones, augmented reality (AR)/virtual reality (VR), robotics).

For example, the existing (standard) NeRF of the related art is configured to receive a coordinate and a viewing angle corresponding to a 3D point and output a color and density at the 3D point. To render an image, in the existing NeRF, ray marching is performed along the ray corresponding to each pixel, which involves sampling multiple points along the ray. This process requires a huge number of MLP calls (e.g., millions MLP calls per one single image), so the process of existing NeRFs takes a long time to render each 3D scene.

### SUMMARY

Provided are a system and a method for improved neural radiance field (NeRF) to render a two dimensional (2D) image representing a three dimensional (3D) scene seen from a view point of interest, for particular applications running electronic devices such as smartphones, augmented reality (AR)/virtual reality (VR), robotics.

According to one aspect of the disclosure, a computer-implemented method for rendering a novel view of an object by using an improved neural radiance field (NeRF) including a latent field about the object and an autoencoder, includes: obtaining a plurality of multiview color images of the object; obtaining, from the latent field about the object, a plurality of multiview latent images and a plurality of camera parameters respectively corresponding to the plurality of multiview latent images; based on the plurality of multiview latent images and the plurality of camera parameters, rendering a first feature map about the object by using the latent field and the autoencoder; based on the first feature map about the object, training the improved NeRF by performing iterative operations; receiving, from a user of an electronic device, a request for the novel view of the object; generating, by using the improved NeRF, a second feature map from the novel view of the object; and generating, by a decoder of the autoencoder, an image about the novel view of the object based on the second feature map; and providing, to the user of the electronic device, the image about the novel view of the object.

According to an aspect of the disclosure, a non-transitory computer-readable recording medium storing a computer program, which, when executable by at least one processor, causes the at least one processor to: obtain a plurality of multiview color images of an object; obtain, from a latent field about the object, a plurality of multiview latent images and a plurality of camera parameters respectively corresponding to the plurality of multiview latent images; based on the plurality of multiview latent images and the plurality of camera parameters, render a first feature map about the object by using the latent field and an autoencoder; based on the first feature map about the object, train the improved NeRF by performing iterative operations; receive, from a user of an electronic device, a request for a novel view of the object; generate, by using the improved NeRF, a second feature map from the novel view of the object; and generate, by a decoder of the autoencoder, an image about the novel view of the object based on the second feature map, and provide, to the user of the electronic device, the image about the novel view of the object.

According to an aspect of the disclosure, an electronic device includes: at least one camera; at least one memory; and at least one processor operatively connected to the at least one camera and the at least one memory, the at least one processor being configured to perform: obtain a plurality of multiview color images of the object; obtain, from the latent field about the object, a plurality of multiview latent images and a plurality of camera parameters respectively corresponding to the plurality of multiview latent images; based on the plurality of multiview latent images and the plurality of camera parameters, render a first feature map about the object by using a latent field and an autoencoder; based on the first feature map about the object, train the improved NeRF by performing iterative operations; receive, from the user of the electronic device, a request for a novel view of the object; generate, by using the improved NeRF, a second feature map from the novel view of the object; generate, by a decoder of the autoencoder, an image about the novel view of the object based on the second feature map; and provide, to the user of the electronic device, the image about the novel view of the object.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates example components of an electronic device in accordance with embodiments of the disclosure;

FIG. 2 illustrates operations of a training phase of ‘reconstructive latent-space NeRF’ (ReLS-NeRF) in accordance with some embodiments of the disclosure;

FIG. 3 illustrates operations of rendering a novel view of an objection in accordance with some embodiments of the disclosure;

FIG. 4 illustrates operations of ReLS-NeRF in accordance with some embodiments of the disclosure;

FIG. 5 shows symbols used in operations of ReLS-NeRF in accordance with some embodiments of the disclosure;

FIG. 6 illustrates operations performed to train ReLS-NeRF and to render novel view of a scene (or an object) by using the trained ReLS-NeRF in accordance with some embodiments of the disclosure; and

FIG. 7 illustrates a computer-implemented method for rendering a novel view of an object by using an improved NeRF including a latent field about the object and an autoencoder, in accordance with some embodiments of the disclosure.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

The disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “Ist” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

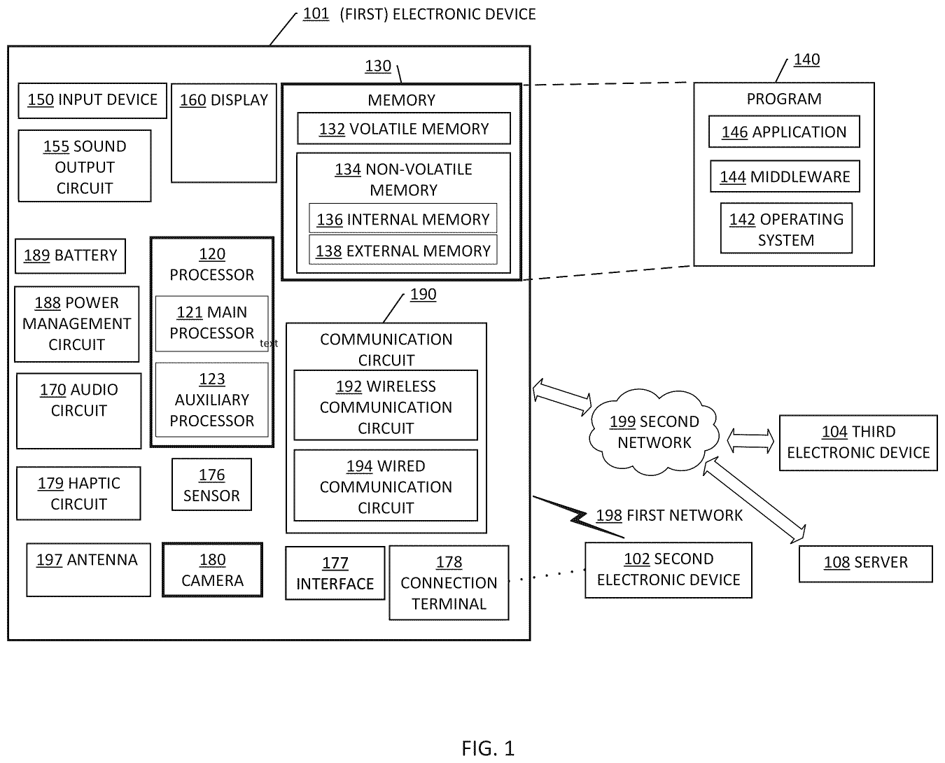

FIG. 1 illustrates example components of the electronic device in accordance with some embodiments of the disclosure.

In FIG. 1, a (first) electronic device 101 may communicate with a second electronic device 102 via a first network 198 (e.g., a short-range wireless communication network), or a third electronic device 104 or a server 108 via a second network 199 (e.g., a long-range wireless communication network). In one embodiment, the (first) electronic device 101 may communicate with the third electronic device 104 via the server 108. Throughout the disclosure, the first electronic device 101 may be referred to as ‘the electronic device 101.’ Hereinafter, components of the electronic device 101 are described. Those components of the electronic device 101 may be also included in the second electronic device 102 or the third electronic device 104. For example, the second electronic device 102 may include a camera that corresponds to the camera 180 included in the (first) electronic device 101. Also, the third electronic device 104 may include a camera that corresponds to the camera 180 included in the (first) electronic device 101. In some embodiments, images or scenes, which are taken by the camera of the second electronic device 102 or the third electronic device 104, may be transmitted (via the first network 198 or the second network 199, respectively) to the (first) electronic device 101. Then, the processor 120 and the memory 130 of the (first) electronic device 101 may perform operations on the received images or scenes.

In one embodiment, the electronic device 101 may include a processor 120, memory 130, an input device 150, a sound output circuit 155, a display 160, an audio circuit 170, a sensor 176, an interface 177, a haptic circuit 179, a camera 180, a power management circuit 188, a battery 189, a communication circuit 190, a subscriber identification module (SIM) 196, or an antenna 197.

In some embodiments, at least one (e.g., the display 160 or the camera 180) of the components may be omitted from the electronic device 101, or one or more other components may be added in the electronic device 101. In some embodiments, some of the components may be implemented as single integrated circuitry. For example, the sensor 176 (e.g., a fingerprint sensor, an iris sensor, or an illuminance sensor) may be implemented as embedded in the display 160 (e.g., a display).

The processor 120 may execute, for example, software (e.g., a program 140) to control at least one other component (e.g., a hardware or software component) of the electronic device 101 coupled with the processor 120, and may perform various data processing or computation. In one embodiment, as at least part of the data processing or computation, the processor 120 may load a command or data received from another component (e.g., the sensor 176 or the communication circuit 190) in volatile memory 132, process the command or the data stored in the volatile memory 132, and store resulting data in non-volatile memory 134. In one embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The processor 120 may refer to or correspond to one or more processors. For example, the electronic device 101 may include two or more processors like the processor 120.

The auxiliary processor 123 may be implemented as separate from, or as part of the main processor 121. The auxiliary processor 123 may control at least some of functions or states related to at least one component (e.g., the display 160, the sensor 176, or the communication circuit 190) among the components of the electronic device 101, instead of the main processor 121 while the main processor 121 is in an inactive (e.g., sleep) state, or together with the main processor 121 while the main processor 121 is in an active state (e.g., executing an application). In one embodiment, the auxiliary processor 123 (e.g., an image signal processor or a communication processor) may be implemented as part of another component (e.g., the camera 180 or the communication circuit 190) functionally related to the auxiliary processor 123.

The memory 130 may store various data used by at least one component (e.g., the processor 120 or the sensor 176) of the electronic device 101. The various data may include, for example, software (e.g., the program 140) and input data or output data for a command related thereto. The memory 130 may include the volatile memory 132 or the non-volatile memory 134. The program 140 may be stored in the memory 130 as software, and may include, for example, an operating system (OS) 142, middleware 144, or an application 146.

One or more embodiments of the disclosure may be implemented as software (e.g., the application 146, the middleware 144, the operating system) including one or more instructions that are stored in the memory 130 (a storage medium) that is readable by the electronic device 101.

For example, the processor 120 of the electronic device 101 may invoke at least one of the one or more instructions stored in the memory 130, and execute the at least one of the one or more instructions, with or without using one or more other components under the control of the processor 120. This allows the electronic device 101 to be operated to perform at least one function according to the at least one instruction invoked. The one or more instructions may include a code generated by a compiler or a code executable by an interpreter. The memory 130, which may be a machine-readable storage medium, may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the memory 130 (the storage medium) and where the data is temporarily stored in the memory 130.

In some embodiments, functions related to artificial intelligence (AI) are operated by the processor 120 (or the main processor 121 or the auxiliary processor 123) and the memory 130. The processor 120 (or the main processor 121 or the auxiliary processor 123) may include or may correspond to a general-purpose processor, such as a CPU, an application processor, or a digital signal processor (DSP), a graphics-dedicated processor, such as a graphics processing unit (GPU) or a vision processing unit (VPU), or an artificial intelligence-dedicated processor, such as a neural processing unit (NPU). The processor 120 (or the main processor 121 or the auxiliary processor 123) may control input data to be processed according to predefined operation rules or artificial intelligence models, which are stored in the memory 130. Alternatively, the processor 120 (or the main processor 121 or the auxiliary processor 123) may be an artificial intelligence-dedicated processor including a hardware structure specialized for processing of an artificial intelligence model.

The predefined operation rules or the artificial intelligence models are made through training. Here, the statement of being made through training means that a basic artificial intelligence model is trained by a learning algorithm by using a large amount of training data, thereby making a predefined operation rule or an artificial intelligence model, which is configured to perform a desired characteristic (or purpose). Such training may be performed in a device itself, in which artificial intelligence according to the disclosure is performed, or may be performed via a separate server or a separate system. Examples of the learning algorithm may include, but are not limited to, supervised learning, unsupervised learning, semi-supervised learning, and reinforcement learning.

The artificial intelligence model may include a plurality of neural network layers. Each of the plurality of neural network layers has a plurality of weight values and performs neural network calculations through calculations between a calculation result of a previous layer and the plurality of weight values. The plurality of weight values of the plurality of neural network layers may be optimized by a training result of the artificial intelligence model. For example, the plurality of weight values may be updated to minimize a loss value or a cost value, which is obtained from the artificial intelligence model during the process of training. An artificial neural network may include a deep neural network (DNN), and examples of the artificial neural network may include, but are not limited to, a random forest model, a convolutional neural network (CNN), a DNN, a recurrent neural network (RNN), a restricted Boltzmann machine (RBM), a deep belief network (DBN), a bidirectional recurrent deep neural network (BRDNN), and deep Q-Networks.

In one embodiment, the improved NeRF (ReLS-NeRF) (a model or a set of operations) of the disclosure may be implemented as software (e.g., the application 146, the middleware 144, the operating system) including one or more instructions that are stored in the memory 130 (a storage medium) that is readable by the electronic device 101.

In one embodiment, the improved NeRF (ReLS-NeRF) of the disclosure may be implemented as at least one hardware component, such as the processor 120, the main processor 121, the auxiliary processor 123, or any combination thereof.

In one embodiment, the improved NeRF (ReLS-NeRF) of the disclosure may be implemented as a combination of the software and the at least one hardware component.

The input device 150 may receive a command or data to be used by other components (e.g., the processor 120) of the electronic device 101, from the outside (e.g., a user) of the electronic device 101. The input device 150 may include, for example, a microphone, a mouse, or a keyboard.

The sound output circuit 155 may output sound signals to the outside of the electronic device 101. The sound output circuit 155 may include, for example, a speaker or a receiver. The speaker may be used for general purposes, such as playing multimedia or playing record, and the receiver may be used for incoming calls. In one embodiment, the receiver may be implemented as separate from, or as part of the speaker.

The display 160 may visually provide information to the outside (e.g., a user) of the electronic device 101. The display 160 may include, for example, a display, a hologram device, or a projector and control circuitry to control a corresponding one of the display, hologram device, and projector. In one embodiment, the display 160 may include touch circuitry adapted to detect a touch, or sensor circuitry (e.g., a pressure sensor) adapted to measure the intensity of force incurred by the touch.

The audio circuit 170 may convert a sound into an electrical signal and vice versa. In one embodiment, the audio circuit 170 may obtain the sound via the input device 150, or output the sound via the sound output circuit 155 or a headphone of an external electronic device (e.g., an electronic device 102) directly (e.g., wiredly) or wirelessly coupled with the electronic device 101.

The sensor 176 may detect an operational state (e.g., power or temperature) of the electronic device 101 or an environmental state (e.g., a state of a user) external to the electronic device 101, and then generate an electrical signal or data value corresponding to the detected state. In one embodiment, the sensor 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. In one embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). In one embodiment, the connecting terminal 178 may include, for example, a HDMI connector, a USB connector, a SD card connector, or an audio connector (e.g., a headphone connector),

The haptic circuit 179 may convert an electrical signal into a mechanical stimulus (e.g., a vibration or a movement) or electrical stimulus which may be recognized by a user via his tactile sensation or kinesthetic sensation. In one embodiment, the haptic circuit 179 may include, for example, a motor, a piezoelectric element, or an electric stimulator.

The camera 180 may capture a still image or moving images. In one embodiment, the camera 180 may include one or more lenses, image sensors, image signal processors, or flashes.

The power management circuit 188 may manage power supplied to the electronic device 101. In one embodiment, the power management circuit 188 may be implemented as at least part of, for example, a power management integrated circuit (PMIC).

The battery 189 may supply power to at least one component of the electronic device 101. In one embodiment, the battery 189 may include, for example, a primary cell which is not rechargeable, a secondary cell which is rechargeable, or a fuel cell.

The communication circuit 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication circuit 190 may include one or more communication processors that are operable independently from the processor 120 (e.g., the application processor (AP)) and supports a direct (e.g., wired) communication or a wireless communication. In one embodiment, the communication circuit 190 may include a wireless communication circuit 192 (e.g., a cellular communication circuit, a short-range wireless communication circuit, or a global navigation satellite system (GNSS) communication circuit) or a wired communication circuit 194 (e.g., a local area network (LAN) communication circuit or a power line communication (PLC) module). A corresponding one of these communication circuits may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication circuits may be implemented as a single component (e.g., a single chip), or may be implemented as multi components (e.g., multi chips) separate from each other. The wireless communication circuit 192 may identify and authenticate the electronic device 101 in a communication network, such as the first network 198 or the second network 199, using subscriber information (e.g., international mobile subscriber identity (IMSI)) stored in the subscriber identification module 196.

The antenna 197 may transmit or receive a signal or power to or from the outside (e.g., the external electronic device) of the electronic device 101. In one embodiment, the antenna 197 may include one or more antennas, and, therefrom, at least one antenna appropriate for a communication scheme used in the communication network, such as the first network 198 or the second network 199, may be selected, for example, by the communication circuit 190 (e.g., the wireless communication circuit 192). The signal or the power may then be transmitted or received between the communication circuit 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In one embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. In one embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

According to one or more embodiments, the electronic device may be one of various types of electronic devices. The electronic devices may include, for example, a portable communication device (e.g., a smart phone), a computer device, a portable multimedia device, a portable medical device, a camera, a wearable device, or a home appliance. In one embodiment of the disclosure, the electronic devices are not limited to those described above.

This disclosure proposes an improved (novel, more efficient, or faster) NeRF model (a set of operations). The improved NeRF of the disclosure may be configured to build ‘low resolution’ NeRFs by adding an encoder/decoder such as an autoencoder (AE).

The AE is a type of artificial neural network (e.g., a convolutional neural network, CNN) used to learn efficient coding of unlabeled data, which correspond to unsupervised learning. The AE learns two functions: an encoding function (an encoder) that transforms the input data, and a decoding function (a decoder) that recreates the input data from the encoded representation.

In this disclosure, the improved NeRF of the disclosure may be trained to output ‘low resolution’ feature vector at a pixel for an image at the viewpoint of interest. During a rendering phase (an inference phase), the improved NeRF may be configured to produce the resolution feature vectors for fewer pixels (which significantly reduces the number of MLP computations required for the existing NeRF) to generate a feature map, and then, use the decoder to upsample the feature map to generate a high-resolution image for the viewpoint of interest.

Throughout the disclosure, the improved NeRF (model or a set of operations) may be called as reconstructive latent-space NeRFs (hereinafter “ReLS-NeRF”).

ReLS-NeRF of the disclosure may be configured to use convolutional neural networks (CNNs) in conjunction with standard NeRF approaches. In some embodiments, the proposed ReLS-NeRF may fix certain visual errors of the 3D objects and scenes, but may also enable faster rendering (processing) of novel views. ReLS-NeRF of the disclosure may be applicable in a variety of particular applications, such as generating and viewing 3D scene captures on smartphones, using NeRF content in AR environments, and enabling online learning for robotics tasks. Unlike existing methods for improving rendering efficiency of the related art, the ReLS-NeRF may not break differentiability or may not induce difficulties in optimization, which is particularly useful for applications for editing and online learning.

In ReLS-NeRF, features ‘Latent space’ and ‘latent field’ are two different but related concepts. The latent space is defined as the space of learned features (e.g., each element of an encoded image). In this disclosure, the latent field is a 3D function, where the input is a 3D position and the output is a latent feature (i.e., an element of the latent space). In other words, the latent field is a way to associate a latent vector (which is an element of or a member of a latent space) to every position in 3D space. Thus, the latent field defines a “3D latent scene” and therefore builds on an existing latent space. In some embodiments, the dimensionality of the latent space may be chosen to be lower than the dimensionality of the space from which the data points are drawn, making the construction of latent space an example of dimensionality reduction, which can also be viewed as a form of data compression. E.g., a color image can be mapped into its encoded form (via an AE), which is generally much lower dimensional (note that each “pixel” in the latent image may be higher dimensional, but the number of latent pixels in such a case will tend to be far fewer). The latent field may be usually fit via machine learning, and the latent field may then be used as feature spaces in machine learning models, including classifiers and other supervised predictors.

In one embodiment of the disclosure, an approach that is orthogonal to existing work designed to improve NeRF efficiency is used to improve an inference speed (or test-time speed) and visual quality of NeRF. By leveraging convolutional AEs, a “NeRF” operating in ‘latent feature space’ (rather than ‘color space’) is defined such that low-resolution latent rendered images (renders) may be decoded to high-resolution RGB rendered images (decoded renders). This may offload expensive MLP-based rendering computations to the low-cost AE. Thus, based on the standard NeRF architecture, ReLS-NeRF of the disclosure is extended to return point-wise latent vectors, in addition to colors and densities. As latent-space NeRF (or ReLS-NeRF) is used for scene reconstruction, the resulting combined field is denoted as a ‘reconstructive latent-space NeRF’ (ReLS-NeRF). Beyond improving the rendering speed, the AE of ReLS-NeRF may also act as an ‘image prior’ and may fix some of the artifacts associated with direct (color-space) NeRF rendered images (renders).

The ‘image prior’ refers to the statistical (Bayesian) notion of a “prior distribution over images,” which encapsulates what a good or natural image should look like. For example, if an image (such as an RGB NeRF rendered images (renders)) has some unnatural noise, then the image does not conform to the “prior” that a person has about what real or error-free images should look like (i.e., it is not following the image prior of the person). In this case, the AE has been trained to encode and decode natural images, and hence has seen many real images. Thus, the AE acts as an ‘image prior’ by helping the images the AE generates follow the distribution of images it has been trained on. This makes it easier to fix artifacts that do not conform to such a prior.

ReLS-NeRF of the disclosure may render views, for example, three times faster, while improving quality metrics for multiple images and multiple videos. This is an example advantage of the embodiments of the disclosure.

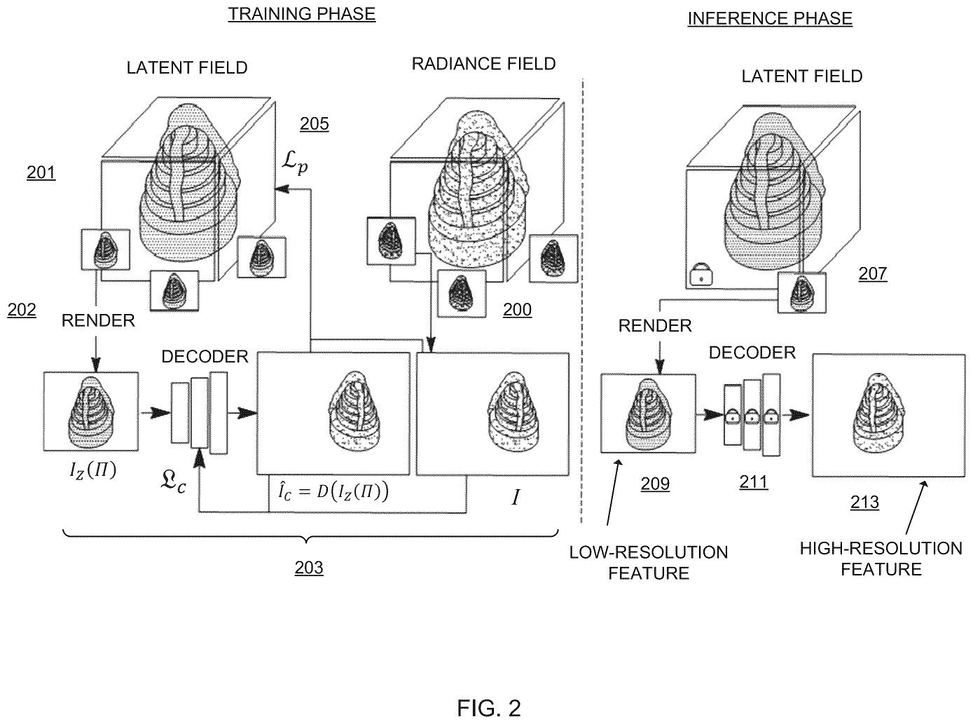

FIG. 2 illustrates operations of a training phase of ReLS-NeRF in accordance with some embodiments of the disclosure. For example, the processor 120 and the memory 130 of the electronic device 101 may perform, alone or in combination, the following operations for the training phases of ReLS-NeRF.

At operation 200, the radiance (color) field (about an object such as a statue shown in FIG. 2) is trained on RGB captured images, as in the standard (existing) NeRF. Then, a plurality of RGB images are rendered from the radiance (color) field.

At operation 201, a plurality of multiview latent images and a plurality of camera parameters, which are respectively associated with the plurality of multiview latent images, are acquired from the latent field.

At operation 202, ReLS-NeRF renders ‘feature maps’ in the latent Z-space defined by a convolutional AE (E. D), for which arbitrary views can be decoded into image space.

At operation 203, random views from the latent field are iteratively rendered, decoded, and compared (to ground truth images or) to the plurality of RGB images rendered from the radiance (color) field. The discrepancy between the decoded plurality of multiview latent images and the corresponding plurality of RGB images enables training the ReLS-NeRF (the Z-space NeRF and the AE).

At operation 205, those random views from the latent field, which are output from operation 203, may be used to train the latent field and the decoder of ReLS-NeRF.

After operations 200 to 205 are performed, for example, by the processor 120 and the memory 130 of the electronic device 101, alone or in combination, the latent field is prepared for an inference phase.

At operation 207, there is a request for a novel view of the object (e.g., the statue shown in FIG. 2), for example, which may be input by a user.

At operation 209, based on the request, the latent field outputs a low-resolution feature (map).

At operations 211 and 213, the decoder of the trained autoencoder receives the low resolution feature map and generates a high-resolution image about the novel view of the object.

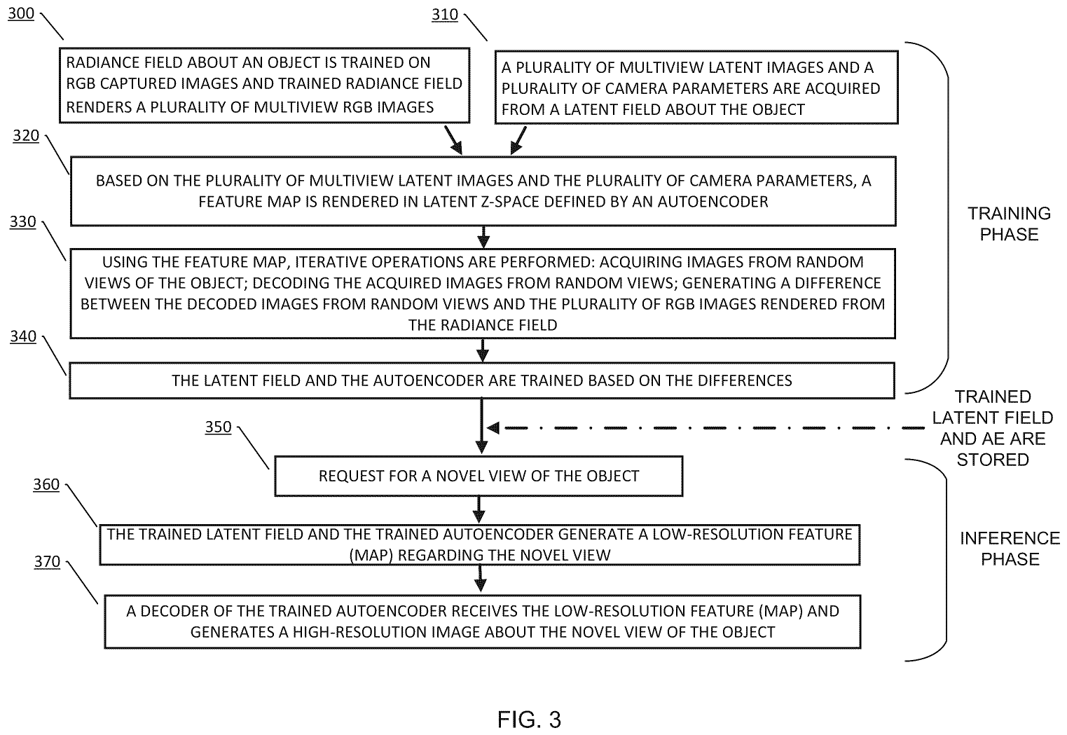

FIG. 3 illustrates operations of rendering a novel view of an objection in accordance with some embodiments of the disclosure. When there is an object (e.g., a statue shown in FIG. 2), a radiance field and a latent field about the object can be obtained.

At operation 300 (corresponding to 200 in FIG. 2), the radiance field about the object is trained on RGB captured images and the trained radiance field renders a plurality of multiview RGB images.

At operation 310 (corresponding to 201 in FIG. 2), a plurality of multiview latent images and a plurality of camera parameters, which are respectively associated with the plurality of multiview latent images, are acquired from the latent field about the object.

At operation 320 (corresponding to 202 in FIG. 2), based on the plurality of multiview latent images and the plurality of camera parameters, a feature map is rendered in latent Z-space defined by an autoencoder.

At operation 330 (corresponding to 203 in FIG. 2), using the feature map, iterative operations are performed, which include acquiring images from random views of the object, decoding the acquired images from random views. Based on the performed iterative operations, differences between the decoded images from random views and the plurality of RGB images (rendered from the radiance field) are obtained.

At operation 340 (corresponding to 205 in FIG. 2), the latent field and the autoencoder are trained based on the differences obtained from the iterative operations. The trained latent field and the trained autoencoder are stored, for example, in the memory 130.

At operation 350 (corresponding to 207 in FIG. 2), there is a request (e.g., from a user) for a novel view of the object. In some embodiments, the user looks at a scene on a smart phone or the user looks at AR content.

At operation 360 (corresponding to 209 in FIG. 2), based on the request, the trained latent field and the trained autoencoder generate a low-resolution feature (map) regarding the novel view.

At operation 370 (corresponding to 211 and 213 in FIG. 2), a decoder of the trained autoencoder receives the low-resolution feature map and generates a high-resolution image about the novel view of the object.

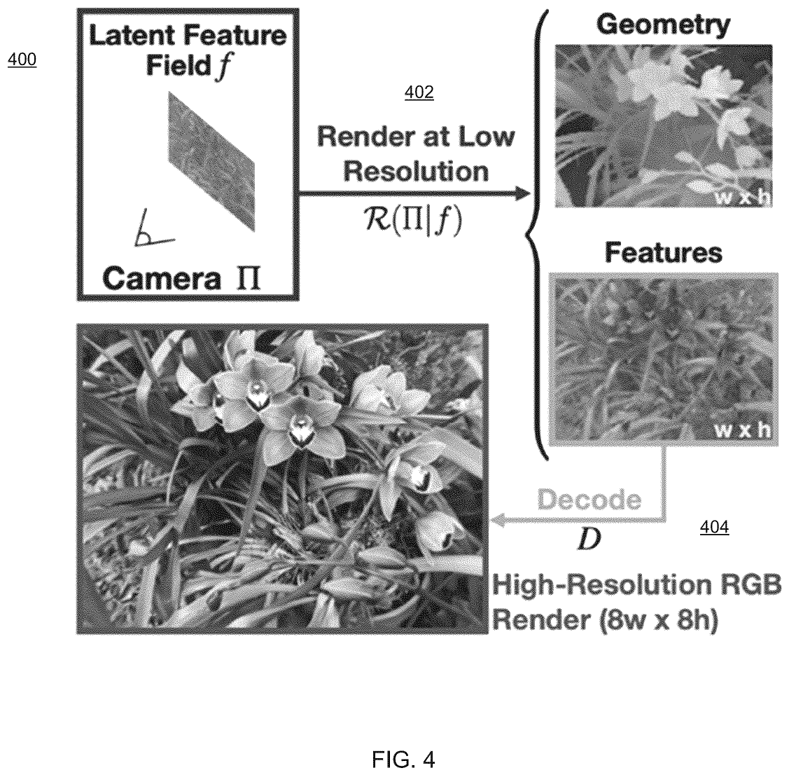

FIG. 4 illustrates operations of ReLS-NeRF of the disclosure in accordance with some embodiments of the disclosure. For example, the processor 120 and the memory 130 of the electronic device 101 may perform, alone or in combination, the following operations for the training phases of ReLS-NeRF.

At operation 400, ReLS-NeRF model includes a latent field (ƒ) and decoder (D) and is fitted (trained) to a scene (e.g., the scene having the flowers and grasses of FIG. 4). Operation 400 of FIG. 3 may correspond to operation 207 of FIG. 2 or operation 140 of FIG. 3.

At operation 402, given a viewpoint of interest (II), using the latent field (ƒ), ReLS-NeRF renders a ‘feature image’ with a low resolution ((width (w)×height (h))). For example, as shown in FIG. 4, the feature image has a geometry (w×h) and features (w×h). Operation 402 of FIG. 3 may correspond to operation 209 of FIG. 2 or operation 160 of FIG. 3.

At operation 404, the decoder (D) of ReLS-NeRF is used to decode the ‘feature image’ (with the low resolution) to a color image (RGB pixels) having a higher resolution (e.g., 8w×8h). As an example, FIG. 4 shows that the resolution of the color image is eight times than the resolution of the ‘feature image.’ Operation 404 of FIG. 3 may correspond to operation 211 of FIG. 2 or operation 170 of FIG. 3.

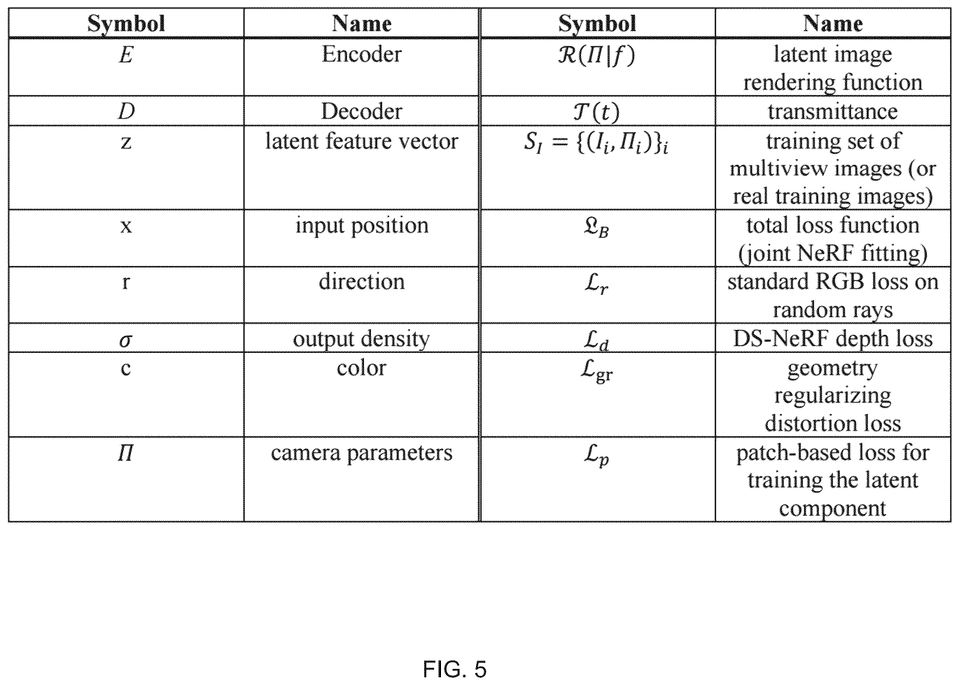

Details of the ReLS-NeRF are described below. FIG. 5 shows symbols used in operations of ReLS-NeRF in accordance with some embodiments of the disclosure. Those symbols are described below.

ReLS-NeRF includes two functional blocks: (i) a modified NeRF (ƒ) which outputs a latent vector from the latent field (in addition to its standard outputs from the radiance field), and (ii) an AE, with an encoder (E) and a decoder (D).

In addition to the standard radiance (color-density) field of NeRF, ReLS-NeRF may further include a latent field including a latent feature vector (z), via ƒ(x,r)=(σ∈ [symbol] ₊, c∈[0,1]³, z∈ [symbol] ⁿ). Here, x and r represent an input position and a direction of ray, respectively. Also, σ and c represent the output density and color, respectively.

The σ field and the c field are referred to as an ‘RGB-NeRF’ to distinguish them from the latent components of ReLS-NeRF. Volume rendering is unchanged as in the existing NeRF: for a single feature at a pixel position, p, the following equation is used for ReLS-NeRF:

$$Z ( p ) = {\int }_{{t}_{min}}^{{t}_{max}} 𝒯 ( t ) σ ( t ) z ( t ) dt ,$$

to obtain the feature value at p (pixel position), where [symbol] (t) is the transmittance, and z(t)=z(x(t),r(t)) is obtained by sampling the ray defined by p. For camera parameters Π, a latent image rendering function is denoted as [symbol] (Π|ƒ)=I_{Z}(Π), where I_{Z}[p]=Z(p).

For example, replacing z(t) with c(t) would render color in the standard manner, giving a color image, I_{C}(Π) (that does not use z). To obtain a color image from I_{Z}, I_{Z} is passed to the decoder (D); i.e., view synthesis is simply Î_{C}(Π)=D(I_{Z}(Π)), which may be viewed as a form of ‘neural rendering.’ The benefit of using Îc is that significantly fewer pixels need to be rendered, assuming the decoder (D) is an upsampler, compared to I_{C}(Π); using Î_{C} also enables placing a prior on Î_{C} by choosing the decoder (D) appropriately.

In some embodiments, for ReLS-NeRF, there may be two choices of the AE: (i) the pretrained ‘variational autoencoder’ (VAE) from stable diffusion denoted as ‘SD-VAE,’ and (ii) a smaller residual block-based AE (R32, when using a 32D latent space) that is randomly initialized. For example, both encoders provide an eight (8) downsampling of the image.

A fitting process (optimization) may be necessary to train the ReLS-NeRF of the disclosure. That is, for a given single 3D scene, a fitting process (optimization) is necessary to obtain a ReLS-NeRF model of this disclosure.

As in the standard NeRF, a training set of multiview images, S_{I}={(Iᵢ,Πᵢ)}ᵢ, is used. The fitting process (optimization) may proceed in the following three phases: (A) AE training, (B) joint NeRF fitting, and (C) decoder fine-tuning.
(A) AE training. In this first phase, the AE may be trained or fine-tuned to reconstruct the training images of the scenes, for example, using the mean-squared error.
(B) Joint NeRF fitting. In this second phase, the RGB and latent components of NeRF are trained in conjunction with the decoder (D). The total loss function is shown below.

$${ℒ}_{B} = {ℒ}_{r} + {λ}_{d} {ℒ}_{d} + {λ}_{gr} {ℒ}_{gr} + {ℒ}_{p} ,$$

This total loss function includes the standard RGB loss on random rays, [symbol] ᵣ, the DS-NeRF depth loss, [symbol] _{d}, the geometry regularizing distortion loss, [symbol] _{gr}, and a patch-based loss for training the latent component, [symbol] ₚ. Given a posed image, (I,Π), the latter loss ( [symbol] ₚ) is simply an error between a sample patch, [symbol] ˜I, and the corresponding rendered-then-decoded patch,

$${ℒ}_{p} = {𝔼}_{𝒫 ∼ I , ( I , Π ) ∼ {S}_{I}} MSE ( 𝒫 , D ( {I}_{Z} ( Π ) ) ) ,$$

where | [symbol] | is the number of pixels in [symbol] . MSE is the ‘mean squared error’ function.
(C) Decoder fine-tuning. Finally, in this third phase, the decoder (D) is fine-tuned, utilizing a combination of S_{I} and rendered images (renders) from the RGB component of ReLS-NeRF. First, random rendered images (renders) are sampled, \tilde{S}_{I}={(I_{C}(Πₛ),Πₛ)|Πₛ˜Γ(S_{Π})}ₛ, where Γ(S_{Π}) is the uniform distribution over extrinsic camera parameters that may be obtained by interpolating between any triplet in S_{Π}={Πᵢ}ᵢ. Optimizing the following loss,

$${ℒ}_{C} = γ δ ( {S}_{I} ) + ( 1 - γ ) δ ( {\tilde{S}}_{I} ) ,$$

where δ(S)= [symbol] _{(I,Π)˜s}MSE(I, Î_{C}(Π)), distills information from the RGB-NeRF into latent rendered images (renders). Note that the real training images, S_{I}, are used; hence, the RGB-NeRF is not strictly a ceiling on performance (further, the presence of the decoder (D) implies different generalization properties).

In some embodiments, ReLS-NeRF may use the “sR32” architecture for the encoder (E) and the decoder (D), as described below. sR32 architecture is a non-limiting example of ReLS-NeRF. In other embodiments, other autoencoders (AEs) can be used for ReLS-NeRF.

In some embodiments, the encoder (E) may have the following structure: C5, RBIN, HD, RBIN, HD, RBIN, HD, RBIN, C1. The components of the encoder (E) are as follows: C5 is a conv-5×5-norm-elu block; RBIN is two residual blocks, each using conv-3×3 and norm; HD is a bilinear halving downscaler; and C1 is just a conv-1×1. For example, the encoder has layer sizes of (32, 128, 128, 256, 256).

In some embodiments, the decoder (D) may have the following structure: C1, RBIN, HU, RBIN, HU, RBIN, HU, RBIN, C1, sigmoid. Components for the decoder (D) are the same as in the encoder (E), except that HU is a bilinear doubling upscaler. For example, the decoder has layer sizes of (256, 256, 128, 128, 32). In some embodiments, both of the encoder (E) and the decoder (D) use the exponential linear unit (ELU) non-linearity and instance normalization as norm.

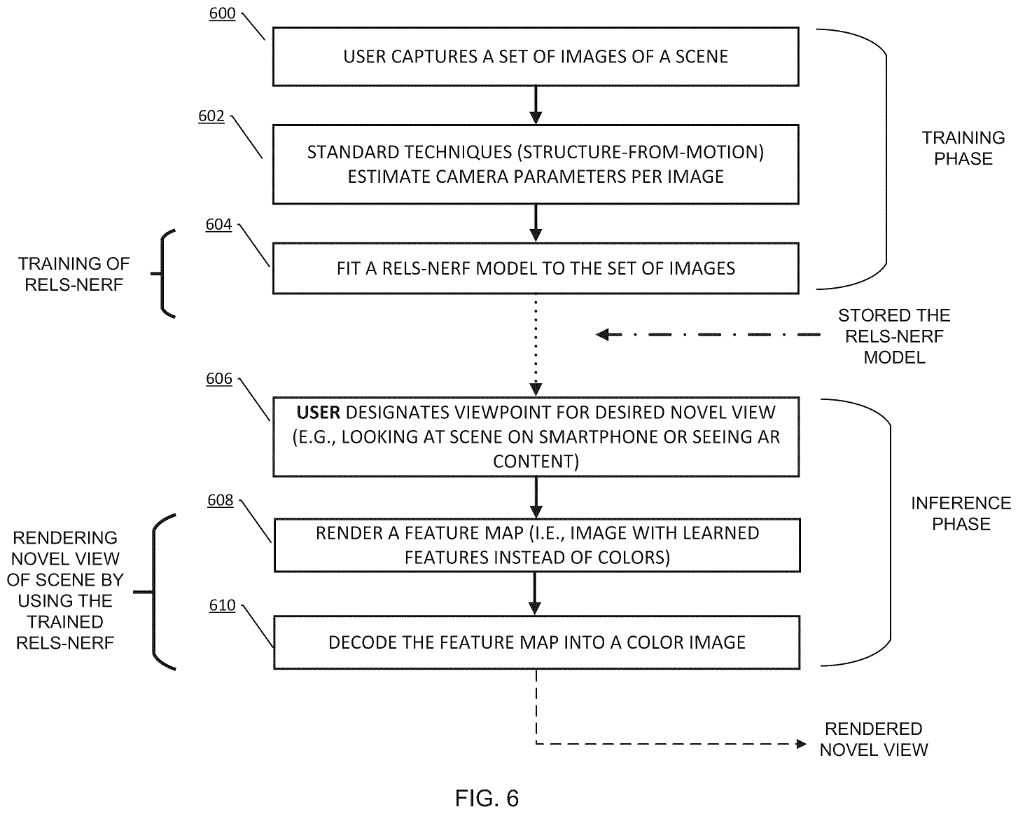

FIG. 6 illustrates operations performed to train ReLS-NeRF and to render novel view of a scene (or an object) by using the trained ReLS-NeRF in accordance with some embodiments of the disclosure. For example, the processor 120 and the memory 130 of the electronic device 101 may perform, alone or in combination, some of the operations illustrated in FIG. 6 and described below.

Operations 600, 602, and 604 relate to acquiring a ReLS-NeRF model that is fitted to (trained on) a set of images about the scene (or an object).

At operation 600, a user of the electronic device 101 captures a set of images about a scene or an object, for example, by using the camera 180.

At operation 602, standard techniques (e.g., structure-from-motion) may be used to estimate camera parameters per each of the images. Structure-from-motion is a class of classical computer vision techniques for estimating various aspects of 3D scene structure from a set of images. In particular, given a set of photographs, such techniques can provide camera parameters (e.g., the location and orientation of the camera in 3D space, as well as properties of the camera's lens) associated to each image in the given set. Such camera parameters can then be used to learn a NeRF, for instance, representing the 3D scene.

At operation 604, ReLS-NeRF is fitted (trained) to the set of the images and the estimated camera parameters. Accordingly, a trained ReLS-NeRF is acquired and stored, for example, the memory 130.

Operations 606, 608, and 610 relate to test-time rendering (inference) of the trained ReLS-NeRF.

At operation 606, a user of the electronic device 101 may designate a viewpoint for a desired novel view of the scene or the object, for example, while the user looks at the scene (or the object) or uses an application showing the scene (or the object) on the electronic device 101 (for example, a smart phone or an AR/VR device).

At operation 608, ReLS-NeRF renders a feature (or a feature map with a low resolution) that includes images with learned features instead of colors.

At operation 610, ReLS-NeRF decodes the feature map (with a low resolution), by using the decoder (D) of the AE (e.g., the CNN) into a color image that corresponds to a novel view of the scene (or the object). The color image may have a higher resolution than the feature map.

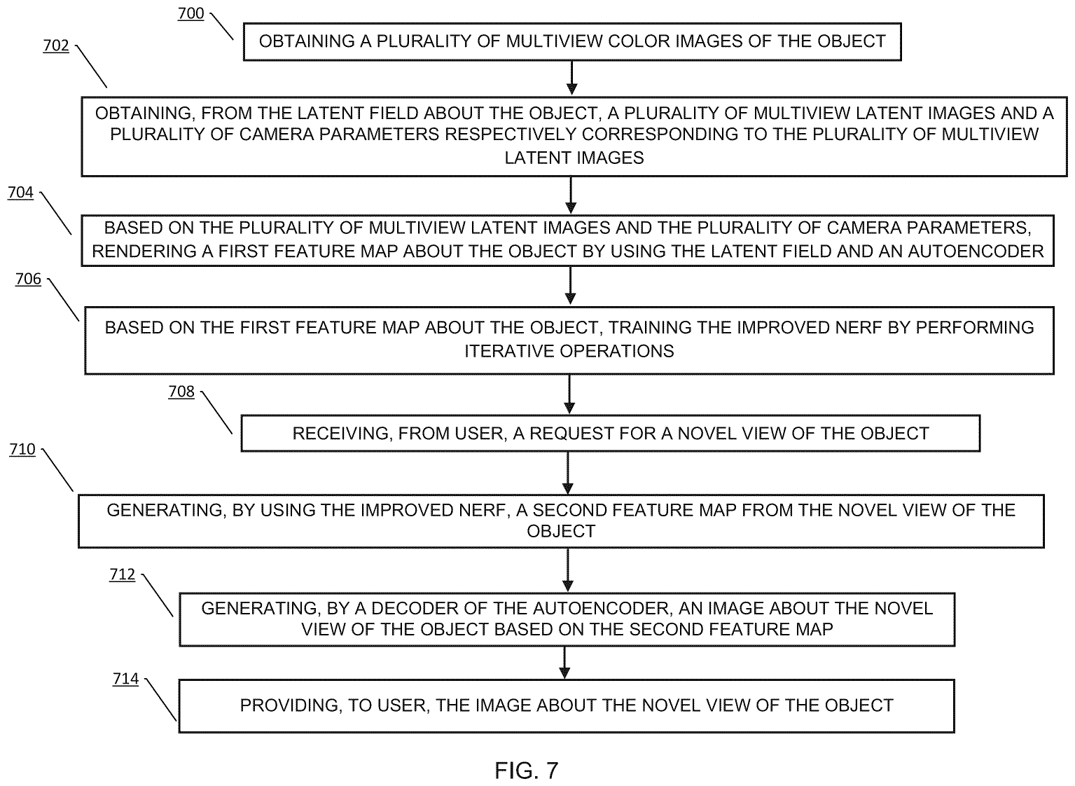

FIG. 7 illustrates a computer-implemented method for rendering a novel view of an object by using an improved neural radiance field (NeRF) comprising a latent field about the object and an autoencoder.

At operation 700, a plurality of multiview color images of the object are obtained.

At operation 702, a plurality of multiview latent images and a plurality of camera parameters (respectively corresponding to the plurality of multiview latent images) are obtained from the latent field about the object.

At operation 704, based on the plurality of multiview latent images and the plurality of camera parameters, a first feature map about the object is rendered by using the latent field and an autoencoder.

At operation 706, based on the first feature map about the object, training the improved NeRF by performing iterative operations.

At operation 708, a request for a novel view of the object is received from a user of an electronic device, for example, storing the improved NeRF of the disclosure.

At operation 710, a second feature map from the novel view of the object is generated by using the improved NeRF.

At operation 712, based on the second feature map, an image about the novel view of the object is generated by a decoder of the autoencoder.

At operation 714, the image about the novel view of the object is provided to the user of the electronic device.

Advantages of ReLS-NeRF of the disclosure are described herein.
1. Rapid rendering. The standard NeRF rendering process requires volume integration per color pixel, necessitating millions of MLP calls to render a single image. Our approach only volume renders a small “feature map”, and then uses an efficient CNN to convert the low-resolution features (or the low-resolution feature maps) to a high-resolution color image, much more efficiently. Our rapid rendering approach is complementary to many other recent rapid rendering NeRF methods.
2. Higher image quality. The use of a learned CNN can repair image artifacts incurred in the standard NeRF setup (e.g., see example on first slide).
3. Controllable speed-quality tradeoff. By altering the architecture of the decoder (D), we can choose to balance rendering speedup with improved image quality. This tradeoff is generally more difficult to control for standard NeRFs.
4. Retaining differentiability and optimizability. The use of a differentiable decoder means that a ReLS-NeRF model is amenable to further optimization (e.g., for “continual learning” in robotics, or for 3D scene editing applications), unlike most existing techniques for improving NeRF efficiency.

Particular Applications of the ReLS-NeRF are described herein.

ReLS-NeRF of this disclosure may be used in multiple devices for their enhanced functionalities. Non-limiting examples of the multiple devices are smart phones and AR/VR devices.

Anywhere that NeRF could be used, ReLS-NeRF of this disclosure may be used instead. Compared with the standard (conventional) NeRF, ReLS-NeRF may be faster (thus, more efficient) to operate and may have higher image quality.

In some embodiments, content creation for AR/VR applications (i.e., creating 3D objects or scenes using multiview photographs) may be a particular application of ReLS-NeRF of this disclosure.

In some embodiments, one could construct 3D media via ReLS-NeRF. For example, just as one saves 2D images in one's smartphone gallery, one could also save 3D scenes into the gallery, by the user taking a set of images with their smartphone and fitting the model to that set, then saving the ReLS-NeRF model. One could then explore a scene captured on the smartphone in 3D (i.e., the user could move a virtual 3D camera around in the scene to view it from new perspectives). Note that the fitting process (and potentially, also the rendering) could be done on the smartphone device or on the cloud.

In some embodiments, in addition to scenes a user may capture himself/herself, one may also want to explore other 3D environments or objects via the faster speeds of ReLS-NeRF (e.g., for videogames, showing a potential customer around a house, exploring products on an online store as 3D objects).

In some embodiments, there are applications related to robotics. For example, by using ReLS-NeRF, some robots build a 3D scene representation to navigate in.

One or more embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

According to one or more embodiments, in a non-volatile storage medium storing instructions, the instructions may be configured to, when executed by at least one processor, cause the at least one processor to perform at least one operation. The at least one operation may include displaying an application screen of a running application on a display, identifying a data input field included in the application screen, identifying a data type corresponding to the data input field, displaying at least one external electronic device, around the electronic device, capable of providing data corresponding to the identified data type, receiving data corresponding to the identified data type from an external electronic device selected from among the at least one external electronic device through a communication circuit, and entering the received data into the data input field.

The embodiments of the disclosure described in the present specification and the drawings are only presented as specific examples to easily explain the technical content according to the embodiments of the disclosure and help understanding of the embodiments of the disclosure, not intended to limit the scope of the embodiments of the disclosure. Therefore, the scope of one or more embodiments of the disclosure should be construed as encompassing all changes or modifications derived from the technical spirit of one or more embodiments of the disclosure in addition to the embodiments disclosed herein.

What is claimed is:

1. A computer-implemented method for rendering a novel view of an object by using an improved neural radiance field (NeRF) comprising a latent field about the object and an autoencoder, the computer-implemented method comprising:
obtaining a plurality of multiview color images of the object;
obtaining, from the latent field about the object, a plurality of multiview latent images and a plurality of camera parameters respectively corresponding to the plurality of multiview latent images;
based on the plurality of multiview latent images and the plurality of camera parameters, rendering a first feature map about the object by using the latent field and the autoencoder; and
based on the first feature map about the object, training the improved NeRF by performing iterative operations of:
receiving, from a user of an electronic device, a request for the novel view of the object;
generating, by using the improved NeRF, a second feature map from the novel view of the object; and
generating, by a decoder of the autoencoder, an image about the novel view of the object based on the second feature map,
providing, to the user of the electronic device, the image about the novel view of the object.

2. The computer-implemented method of claim 1, wherein the obtaining the plurality of multiview color images of the object comprises obtaining the plurality of multiview color images of the object from a radiance field about the object, and
wherein the radiance field is trained with the plurality of multiview color images of the object.

3. The computer-implemented method of claim 1, wherein the improved NeRF is reconstructive latent-space NeRF (ReLS-NeRF) model.

4. The computer-implemented method of claim 1, wherein the iterative operations comprise:
acquiring images from random views of the object;
decoding the acquired images from random views of the object by using the decoder of the autoencoder;
generating differences between the decoded images from random views of the object and the plurality of multiview color images, and
wherein the training the improved NeRF comprises receiving the differences and adjusting parameters of the improved NeRF based on the received differences.

5. The computer-implemented method of claim 1, wherein the receiving the request for the novel view of the object comprises receiving the request from a user of an electronic device.

6. The computer-implemented method of claim 1, wherein the latent field comprises latent feature vectors associated to an input position and a direction of ray moving toward the object.

7. A non-transitory computer-readable recording medium storing a computer program, which, when executable by at least one processor, causes the at least one processor to:
obtain a plurality of multiview color images of an object;
obtain, from a latent field about the object, a plurality of multiview latent images and a plurality of camera parameters respectively corresponding to the plurality of multiview latent images;
based on the plurality of multiview latent images and the plurality of camera parameters, render a first feature map about the object by using the latent field and an autoencoder;
based on the first feature map about the object, train the improved NeRF by performing iterative operations;
receive, from a user of an electronic device, a request for a novel view of the object;
generate, by using the improved NeRF, a second feature map from the novel view of the object;
generate, by a decoder of the autoencoder, an image about the novel view of the object based on the second feature map; and
provide, to the user of the electronic device, the image about the novel view of the object.

8. The non-transitory computer-readable recording medium of claim 7, wherein the computer program further causes the at least one processor to obtain the plurality of multiview color images of the object from a radiance field about the object, and
wherein the radiance field is trained with color images on the object.

9. The non-transitory computer-readable recording medium of claim 7, wherein the improved NeRF is reconstructive latent-space NeRF (ReLS-NeRF) model.

10. The non-transitory computer-readable recording medium of claim 7, wherein the iterative operations comprise:
acquiring images from random views of the object;
decoding the acquired images from random views of the object by using the decoder of the autoencoder;
generating differences between the decoded images from random views of the object and the plurality of multiview color images, and
wherein the training the improved NeRF comprises receiving the differences and adjusting parameters of the improved NeRF based on the received differences.

11. The non-transitory computer-readable recording medium of claim 7, wherein the computer program further causes the at least one processor to receive the request from a user of an electronic device.

12. The non-transitory computer-readable recording medium of claim 7, wherein the latent field comprises a latent feature vectors about an input position and a direction of ray moving toward the object.

13. An electronic device comprising:
at least one camera;
at least one memory; and
at least one processor operatively connected to the at least one camera and the at least one memory, the at least one processor being configured to:
obtain a plurality of multiview color images of the object;
obtain, from the latent field about the object, a plurality of multiview latent images and a plurality of camera parameters respectively corresponding to the plurality of multiview latent images;
based on the plurality of multiview latent images and the plurality of camera parameters, render a first feature map about the object by using a latent field and an autoencoder;
based on the first feature map about the object, train the improved NeRF by performing iterative operations;
receive, from a user of the electronic device, a request for a novel view of the object;
generate, by using the improved NeRF, a second feature map from the novel view of the object;
generate, by a decoder of the autoencoder, an image about the novel view of the object based on the second feature map, and
provide, to the user of the electronic device, the image about the novel view of the object.

14. The electronic device of claim 13, wherein the at least one processor is further configured to obtain the plurality of multiview color images of the object from a radiance field about the object, and
wherein the radiance field is trained with color images on the object.

15. The electronic device of claim 13, wherein the improved NeRF is reconstructive latent-space NeRF (ReLS-NeRF) model.

16. The electronic device of claim 13, wherein the iterative operations comprise:
acquiring images from random views of the object;
decoding the acquired images from random views of the object by using the decoder of the autoencoder; and
generating differences between the decoded images from random views of the object and the plurality of multiview color images,
wherein the training the improved NeRF comprises receiving the differences and adjusting parameters of the improved NeRF based on the received differences.

17. The electronic device of claim 13, wherein the at least one processor is further configured to receive the request from a user of the electronic device.

18. The electronic device of claim 13, wherein the latent field comprises a latent feature vectors about an input position and a direction of ray moving toward the object.
